(19) United States
(12) Patent Application Publication
(10) Pub. No.: US 2002/0067362 A1
(43) Pub. Date: Jun. 6, 2002

(54) Method and system generating an avatar animation transform using a neutral face image

(76) Inventors: Luciano Pasquale Agostino Nocera, Los Angeles, CA (US); Hartmut Neven, Santa Monica, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/915,235

(22) Filed: Jul. 24, 2001

Related U.S. Application Data
(63) Continuation-in-part of application No. 09/188,079, filed on Nov. 6, 1998.
(60) Provisional application No. 60/220,330, filed on Jul. 24, 2000.

(51) Int. Cl. G06T 13/00

(52) U.S. Cl. 345/473

(57) ABSTRACT

The present invention is embodied in a method and system for generating an animation transform using a neutral face image. An avatar editor uses a frontal head image and a side head image of a neutral face model for generating an avatar. The avatar is generated by automatically finding head feature locations on the front and side head images using elastic bunch graph matching. Significant time savings may be accomplished by a generating an animation transform using the neutral face features. The animation transform for the neutral face features may be applied to the other facial expression avatar meshes to improve the quality of the resulting avatar. The neutral-face-based animation transform provides significant improvement to the facial expression head models without the significant editing time incurred by generating a particular animation transform for each particular facial expression (and/or pose) features.

### CROSS-REFERENCE TO RELATED APPLICATIONS

This application claims priority under 35 U.S.C. §119(e)(1) and 37 C.F.R. § 1.78(a)(4) to U.S. provisional application serial No. 60/220,330, entitled METHOD AND SYSTEM FOR GENERATING AN AVATAR ANIMATION TRANSFORM USING A NEUTRAL FACE IMAGE and filed Jul. 24, 2000; and claims priority under 35 U.S.C. § 120 and 37 C.F.R. § 1.78(a)(2) as a continuation-in-part to U.S. patent application Ser. No. 09/188,079, entitled WAVELET-BASED FACIAL MOTION CAPTURE FOR AVATAR ANIMATION and filed Nov. 6, 1998. The entire disclosure of U.S. patent application Ser. No. 09/188,079 is incorporated herein by reference.

### BACKGROUND OF THE INVENTION

The present invention relates to avatar animation, and more particularly, to generation of an animation transform using a neutral face image.

Virtual spaces filled with avatars are an attractive the way to allow for the experience of a shared environment. However, manual creation of a photo-realistic avatar is time consuming and automated avatar creation is prone to artifacts and feature distortion.

Accordingly, there exists a significant need for an avatar editor for quickly and reliably generating an avatar head model. The present invention satisfies this need.

### SUMMARY OF THE INVENTION

The present invention is embodied in a method, and related system, for generating an avatar animation transform using a neutral face image. The method may include providing a neutral-face front head image and a side head image for generating an avatar and automatically finding head feature locations on the front head image and the side head image using elastic bunch graph matching. Nodes are automatically positioned at feature locations on the front head image and the side head image. The node positions are manually reviewed and corrected to remove artifacts and minimize distorted features in the avatar generated based on the node positions.

The method may further include generating an animation transform based on the corrected node positions for the neutral face. The method also may include applying the animation transform to expression face avatar meshes for generating the avatar.

Other features and advantages of the present invention should be apparent from the following description of the preferred embodiments taken in conjunction with the accompanying drawings, which illustrate, by way of example, the principles of the invention.

### BRIEF DESCRIPTION OF THE DRAWINGS

FIG. 1 is a flow diagram for illustrating a method for generating an avatar animation transform using a neutral face image, according to the present invention.

FIG. 2 is an image of an avatar editor for generating an avatar, according to the present invention.

FIG. 3 is an image of a rear view of an avatar generated using anchor points provided by the avatar editor of FIG. 2.

FIG. 4 is an image of an avatar editor for generating an avatar using anchor point positions corrected to remove artifacts and distortions from the avatar image, according to the present invention.

FIG. 5 is an image of a rear view of an avatar generated using the corrected anchor point positions shown in FIG. 4, according to the present invention.

FIG. 6 is a graph of facial expression features versus avatar mesh for linear regression mapping of sensed facial features to an avatar mesh.

### DETAILED DESCRIPTION OF THE PREFERRED EMBODIMENTS

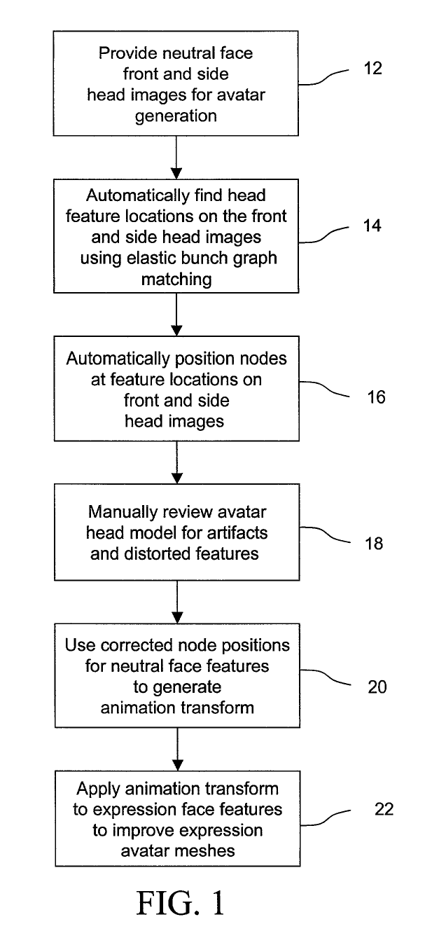

The present invention is embodied in a method, shown in FIG. 1, and a system for generating an animation transform using a neutral face image. An avatar editor uses a frontal head image and a side head image of a neutral face model for generating an avatar (block 12). The avatar is generated by automatically finding head feature locations on the front and side head images using elastic bunch graph matching (block 14). Locating features in an image using elastic bunch graph matching is described in U.S. patent application Ser. No. 09/188,079. In the elastic graph matching technique, an image is transformed into Gabor space using a wavelet transformations based on Gabor wavelets. The transformed image is represented by complex wavelet component values associated with each pixel of the original image. Elastic bunch graph matching automatically places node graphs having anchor points on the front and side head images, respectively. The anchor points are placed at the general location of facial features found using the matching process (block 16).

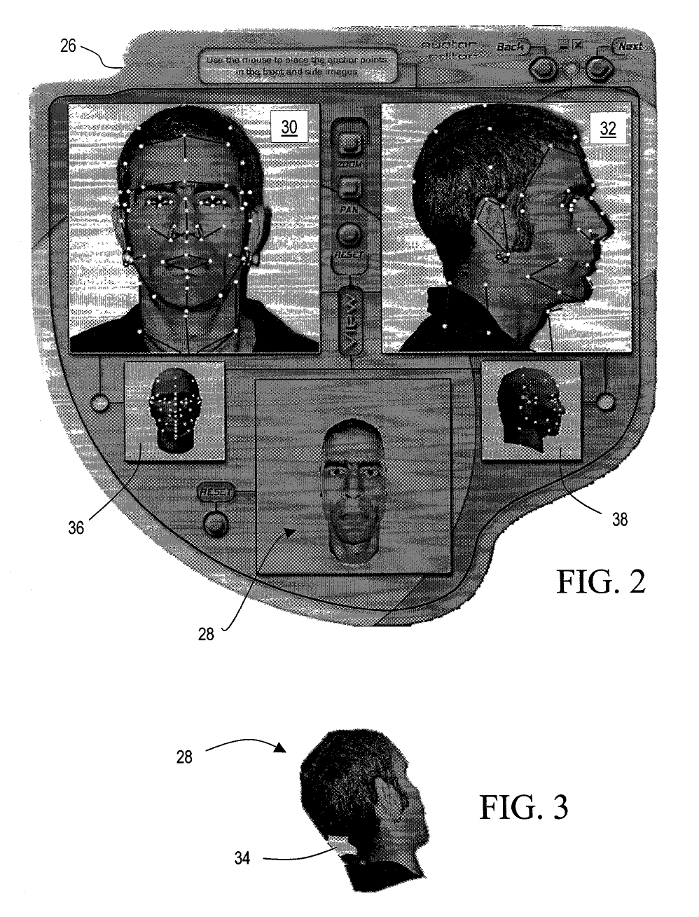

An avatar editor window 26, shown in FIG. 2, allows a user to generate an avatar that looks and appears similar to a model. A new avatar 28 is generated based on the front head image 30 and a side head image 32 of the model. Alternatively, an existing avatar may be edited to the satisfaction of the user. The front and side images are mapped onto an avatar mesh. The avatar may be animated or driven by moving drive control points on the mesh. The motion of the drive control points may be directed by facial feature tracking.

Initially, the avatar editor window 26 includes a wizard (not shown) that leads the user through a sequence of steps for allowing the user to improve the accuracy of tracking of an avatar tracker. The avatar wizard may include a tutor face that prompts the user to make a number of expressions and varying head poses. An image is taken for each expression or pose and facial features are automatically located for each face image. However, certain artifacts of the image may cause the feature process to place feature nodes at erroneous locations. In addition, correct node locations may generate artifacts that detract from a photo-realistic avatar. Accordingly, the user has the opportunity to manually correct the positions of the automatically located features (block 18).

For example, the front and side head images, 30 and 32, shown in FIG. 2 have a shadow outline that is erroneously detected as the profile outline of the side head image 32. Also certain features, such as the model's ears, have numerous patterns which may cause erroneous node placement. Of particular importance is proper placement of the nodes for the eyes and for the mouth. The avatar 28 may have artificial eye and teeth inserts that are “exposed” while the eyes and/or the mouth are open. Accordingly, although the matching process is able to correctly locate the nodes, of the resulting avatar may have distracting features.

Empirical adjustment of the node locations may result in a more photo-realistic avatar. As an example, a rear view of the avatar 28, shown in FIG. 3, is generated using the node locations shown in the avatar editor window 26 of FIG. 2. A particularly distracting artifact is a white patch 34 on the rear of the head. The white patch appears because the automatically placed node locations cause a portion of the white background of the side head image 32 to be patched onto the rear of the avatar.

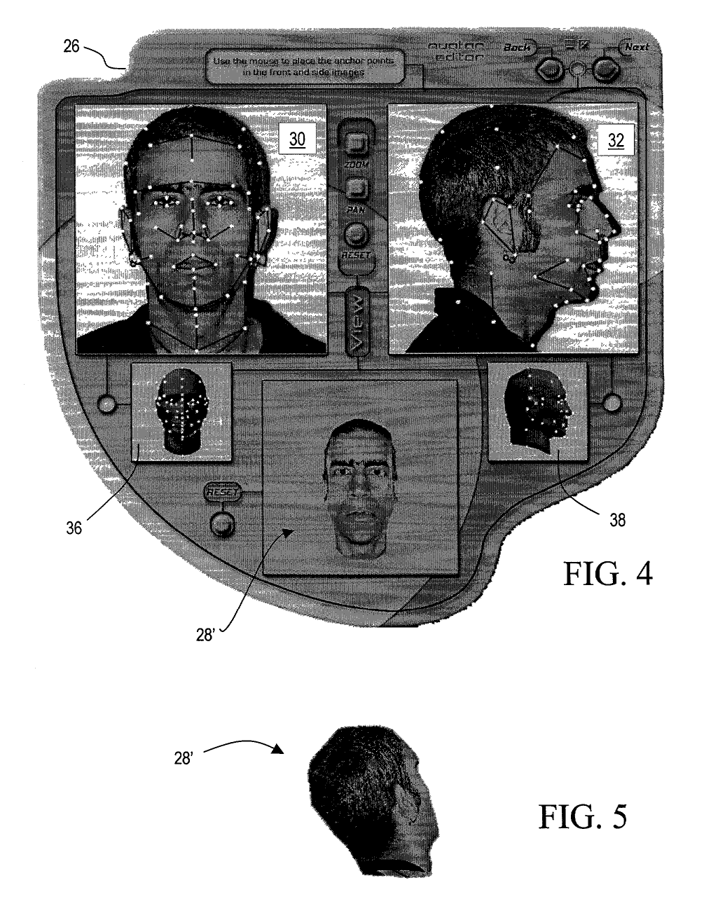

The incorrectly placed nodes may be manually adjusted, at shown in FIG. 4, for more accurate placement of the nodes to the corresponding features. Generic head models, 36 and 38, have the node locations indicated so that a user may correctly place the node locations on the front and side head images. A node is moved by clicking a pointer, such as a mouse, on the node and dragging the node to the desired position. As seen by the front view of the avatar 28′, the avatar based on the corrected node positions is a more photo-realistic avatar. Further, the node locations at the back of the head on the side head image are adjusted to eliminate the distracting white patch as shown in FIG. 5.

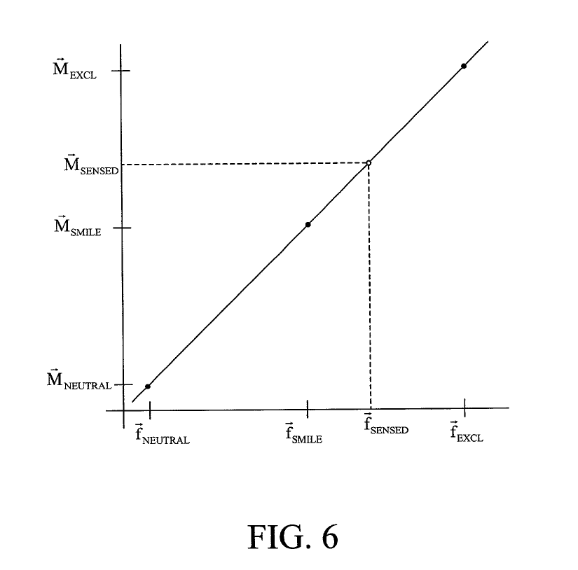

The model images shown in FIGS. 2-5 are of a neutral face. As discussed above, images for a variety of facial expressions and poses are captured using training facial expressions. As shown in FIG. 6, facial expression features \vec{f} are sensed and the resulting parameters may be mapped to corresponding avatar meshes \vec{M} by a transform T(\vec{M}=T(\vec{f})). Using several avatar meshes corresponding to a variety of facial expressions allows for more accurate depiction of a sensed facial expressions. Meshes for different expressions may be referred to as morph targets. For example, one avatar mesh \vec{M}_{SMILE} may be generated using features \vec{F}_{SMILE} from smiling face images. Another avatar mesh \vec{M}_{EXCL} may be generated using a facial features \vec{f}_{EXCL} from face images showing surprise or exclamation. Likewise, the neutral facial features \vec{f}_{NEUTRAL} correspond the avatar mesh \vec{M}_{NEUTRAL}. Sensed facial features \vec{f}_{SENSED} may be mapped to a corresponding avatar mesh \vec{M}_{SENSED} using linear regression.

For a more photo-realistic effect, the node positions for each expression should be manually reviewed and artifacts and distortions addressed for each can model. However, empirical experience has shown that correction for each avatar head model may take several minutes of editing time. A photo-realistic avatar may require as many as 14 to 18 expression-based avatars meshes.

Significant time savings may be accomplished by a generating an animation transform p using the neutral face features \vec{f}_{NEUTRAL} (block 20—FIG. 1). The resulting avatar mesh M_{NEUTRAL}^{T} is related to a generic avatar mesh M_{NEUTRAL}^{G} by the avatar transform as indicated in equation 1.

M_{NEUTRAL}^{T}=ρ·M_{NEUTRAL}^{G} Equation 1

The animation transform for the neutral face features may be applied to the other facial expression avatar meshes to improve the quality of the resulting avatars (block 22). For example, the avatar mesh associated with a smile may be transformed by the neutral face animation transform p as indicated in equation 2.

M_{SMILE}^{T}=ρ·M_{SMILE}^{G} Equation 2

The neutral face-based animation transform provides significant improvement to the facial expression head models without the significant editing time incurred by generating a particular animation transform for each particular facial expression (and/or pose).

Although the foregoing discloses the preferred embodiments of the present invention, it is understood that those skilled in the art may make various changes to the preferred embodiments without departing from the scope of the invention. The invention is defined only by the following claims.

We claim:

1. A method for generating an avatar animation transform, comprising:
providing a neutral-face front head image and a side head image for generating an avatar;
automatically finding head feature locations on the front head image and the side head image using elastic bunch graph matching;
automatically positioning nodes at feature locations on the front head image and the side head image; and
manually reviewing and correcting the node positions to remove artifacts and minimize distorted features in the avatar generated based on the node positions.

2. A method for generating an avatar animation transform as defined in claim 1, further comprising generating an animation transform based on the corrected node positions for the neutral face.

3. A method for generating an avatar animation transform as defined in claim 2, further comprising applying the animation transform to expression face avatar meshes for generating the avatar.

4. A method for generating an avatar animation transform as defined in claim 2, further comprising applying the animation transform to morph targets.

5. A system for generating an avatar animation transform, comprising:
means for providing a neutral-face front head image and a side head image for generating an avatar;
means for automatically finding head feature locations on the front head image and the side head image using elastic bunch graph matching;
means for automatically positioning nodes at feature locations on the front head image and the side head image; and
means for manually reviewing and correcting the node positions to remove artifacts and minimize distorted features in the avatar generated based on the node positions.

6. A system for generating an avatar animation transform as defined in claim 5, further comprising means for generating an animation transform based on the corrected node positions for the neutral face.

7. A system for generating an avatar animation transform as defined in claim 6, further comprising means for applying the animation transform to expression face avatar meshes for generating the avatar.

8. A system for generating an avatar animation transform as defined in claim 6, further comprising means for applying the animation transform to morph targets.

9. A method for generating an avatar animation transform, comprising:
providing a neutral-face front head image and a side head image for generating an avatar;
automatically finding head feature locations on the front head image and the side head image using image analysis based on wavelet component values generated from wavelet transformations of the respective neutral-face front head image and the side head image;
automatically positioning nodes at feature locations on the front head image and the side head image; and
manually reviewing and correcting the node positions to remove artifacts and minimize distorted features in the avatar generated based on the node positions.

10. A method for generating an avatar animation transform as defined in claim 9, further comprising generating an animation transform based on the corrected node positions for the neutral face.

11. A method for generating an avatar animation transform as defined in claim 10, further comprising applying the animation transform to expression face avatar meshes for generating the avatar.

12. A method for generating an avatar animation transform as defined in claim 10, further comprising applying the animation transform to morph targets.

13. A method for generating an avatar animation transform as defined in claim 9, wherein the wavelet transformations use Gabor wavelets.
